(19) United States
(12) Patent Application Publication
(10) Pub. No.: US 2007/0248711 A1
(43) Pub. Date: Oct. 25, 2007

(54) Portioning unit

(76) Inventors: Karl Heinz Brunner, Nazareth, PA (US); Otto Schutz, Munchen (DE)

Correspondence Address: HEAD, JOHNSON & KACHIGIAN, 228 W 17TH PLACE, TULSA, OK, 74119, US

(21) Appl. No.: 11/788,907

(22) Filed: Apr. 23, 2007

(30) Foreign Application Priority Data
Apr. 21, 2006 (DE) 102006018626.5-23

(51) Int. Cl. B28B 3/12; B28B 5/00

(52) U.S. Cl. 425/363; 426/496

(57) ABSTRACT

In a dough billet kneading machine, in order to be able to remove and clean the partitioning cylinders, which are radially moveable in the partitioning drum, they are grouped in a linear manner into cylinder bars along a generatrix, and these cylinder bars can not be removed in axial direction, but in radial direction, greatly reducing the space required for maintenance operations.

### CROSS-REFERENCE TO RELATED APPLICATIONS

This application claims priority to German Patent Application No. 10 2006 018 626.5-23 filed 21 Apr. 2006.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

(1) Field of the Invention

This invention relates to portioning units for doughy materials, especially dough in bakeries, as employed in the partitioning of a large charge of dough into defined small portions or dough billets.

(2) Background Art

Portioning units are used in industrial baking plants for the partitioning of finished dough according to a preset weight into individual dough pieces (herein referred to as dough billets) and are used to additionally form the dough billets into a flat, round shape, similar to that of a wheel of cheese. However, it is not sufficient to achieve this shape, e.g. after portioning of the dough charge by weight, through forming by means of suitable press plungers. Rather, this shape can be achieved solely through working the dough, i.e. kneading, turning and/or similar impacting of the dough billets.

For this purpose, automatic dough billet kneading machines are already known which first partition finished dough in a portioning unit into individual dough billets of preset weight, subsequently subjecting the dough billets in a kneading unit to respective kneading operations, wherein the finished dough billets are subsequently proofed for consistency with their target weight and dimensions, and then are distributed by means of so-called spreader conveyor belts in several adjacent tracks, which either convey them to a subsequent kneading unit or to a manual kneading station.

The core component of the portioning unit is the so-called partitioning drum which has radial indentations disposed on its circumference—typically several of them along individual generatrices of the partitioning drum—the depth of which and, therefore, their displacement being defined by partitioning pistons which form the bottom of the indentations.

During rotation of the partitioning drum, the dough is being pressed into the indentations, i.e. the partitioning cylinders, in a certain rotational position, by means of a pusher extending along the entire generatrix of the partitioning drum.

Through a shearing edge securely mounted to the housing and close to the circumferential surface of the partitioning drum, the dough, which has previously been pressed in, is sheared off through further rotation and divided into particular dough volumes, so-called dough billets, which are located within the dough cylinders. Whenever the next generatrix with partitioning cylinders reaches the rotational position of the radially impacting pusher, the radial pusher again pushes dough into the partitioning cylinders.

The almost continuously rotating partitioning drum, while alternating between fast and slow rotations, moves so that the filled dough cylinders are rotating downward, usually already emptying downward after approximately ¼ of a rotation. Such emptying presently occurs, on the one hand, through gravity affecting the dough and, on the other hand, through the assistance of a compression spring acting upon the rear of the partitioning piston relative to the partitioning drum.

For this reason, the radial pusher does not only have to overcome the viscosity of the dough, but also the spring force of the partitioning pistons needs to be overcome in order to achieve complete filling of the cylindrical spaces so that relatively high forces have to impact upon the finished dough, thus adversely affecting its structure.

Allowing for varying dough consistencies with respect to viscosity and pressure resistance is not possible with this setup.

The dough billets produced by the partitioning drum are subsequently moved into indentations (e.g. hexagonal indentations also disposed on the circumference of the so-called kneading drum) where, despite the continuing rotation of the kneading drum, they are contained and kneaded by means of a kneading belt at least partially covering the kneading drum.

A drawback to this type of setup is the large time effort for cleaning and repairing the machine, which depending on the amount of dough being processed could be nearly as large as its operating time.

The dismantling required for cleaning the partitioning drum is very time consuming, and the proper assembly is difficult, resulting in such work being carried out relatively infrequently and in the development of older deposits and contamination in hard-to-access locations which do not conform to modern tenets of hygiene.

### BRIEF SUMMARY OF THE INVENTION

Therefore, it is an objective of the present invention to create a portioning unit, and in particular a partitioning drum for same, which facilitates cleaning, maintenance, and repair and which in particular allows for a respective retrofitting of the portioning unit.

Larger components are created by combining all individual portioning cylinders positioned along a generatrix into one cylinder bar so that only a few cylinder bars need to be removed and reinstalled instead of a multitude of individual portioning cylinders.

When removing such cylinder bars in axial direction it has proven to be disadvantageous because sufficient space has to be provided next to the partitioning drum and, furthermore, because the frontal head pieces of the partitioning drum must allow such extraction which would require substantial additional work, especially when retrofitting a portioning unit with such a partitioning drum.

Both of these drawbacks are eliminated by a radial removal of the bars.

A secure fixing in operating position is achieved through positively locking the cylinder bars into the partitioning drum by radially inserting the cylinder bars, though axially offset by a certain amount relative to the final operating position, and subsequent axial shifting into the operating position.

Through axial shifting, protrusions located on outer surfaces of the cylinder bar, which are located there in sections, are moved in axial direction below respective opposing protrusions, which are radially located outside of the protrusions of the cylinder bars. The axial motion and the securing in the operating position is effectuated, preferably, by means of a manually operated threaded spindle which is supported at one of the frontal head pieces of the partitioning drum, and relative to which it moves and secures one cylinder bar at a time into its operating position and secures it there or extracts it from the operating position.

By having not just the portioning pistons but the entire cylinder bar made of plastic material, preferable POM (Polyoxymethylen), and not requiring any embedded metal components, such cylinder bars can be manufactured relatively simply and inexpensively through machining plastic blocks. After removing the cylinder bars from the partitioning drum, cleaning of the bars, especially by mechanical means, is considerably simplified, as when mounted in the partitioning drum.

The axial shifting for securing the cylinder bars in a form locking manner corresponds maximally to the diameter of a portioning cylinder, and the protrusions along side surfaces of the cylinder bars are each preferably associated with one partitioning cylinder.

All components of the partitioning drum next to the portioning cylinder which axially extend into its radial area, thus, also the frontal head pieces and e.g. their drive gears for the partitioning drum, are further removed in an axial direction from the cylinder bar in operating position than the axial distance of offset, in order to assure assembly and disassembly without problems.

In spite of this mounting method of the cylinder bars, stroke of the portioning pistons in the mounting bars is adjustable by having a rear side of the portioning pistons, which is protruding inwards from an interior side of the cylinder bar, rest against a stop curve.

The stop curve is notably a sheet metal guide plate extending over the entire length of the partitioning drum which allows for all portioning pistons situated on a given generatrix to be synchronously actuated. For this purpose, the guide plate disposes of a constant profile in axial direction.

The guiding plate can also be divided into individual segments in axial direction which, however, only increases manufacturing costs while keeping the profile constant in axial direction. A sequence of guide curves with different shapes in axial direction for the individual partitioning pistons or the axial sections of the partitioning drum is possible, e.g. in order to produce dough billets of different sizes with one partitioning drum; however, it increases manufacturing costs for the guide curve and for the support cam supporting the guide curve from its radially anterior, radially inner surface.

The stroke of the partitioning piston and, thereby the size of the dough billets, is adjusted by setting the guiding curve, which can be pivoted between an exterior and an interior pivoting position, constituting the posterior stop of the portioning piston, in a certain pivoting position.

For this purpose, a shaft is provided on the rotational axis of the partitioning drum and rotatably arranged relative to the partitioning drum, which is equipped with one single continuous or multiple separate inter-aligned eccentric cam lobes, on the exterior contour of which the rear side of the guiding curve is supported.

By turning the cam shaft, the cam lobe moves the guiding curve outward to a lesser or higher degree from its inner position towards its outer position whereby a spring secures the guiding curve against lifting off from the cam lobe.

The frame of the partitioning drum, in which on the one hand the guiding plate with its supporting cam lobe and the cylinder bars are mounted, is composed of radial, approximately star-shaped rib segments in welded construction which are axially spaced from each other, placed and welded in place on circle-segment shaped outer surfaces of enveloping plates which close the open spaces between the grooves for the cylinder bars towards the outside.

In axial direction, the partitioning drum is completed by inserted head pieces serving as end covers, usually provided as turned parts.

As the extent of contamination, especially with doughs of low viscosity, depends significantly on the amount of dough leaking between filling funnel and the rotating partitioning drum being subjected to pressure, the partitioning drum at its axial ends is fitted with a circumferential circular shoulder which the funnel or dough reservoir envelops from the outside in an interlocking manner.

This provides an interlocking guide, as well as a mutual seal between partitioning drum and dough reservoir, constituting a form of a labyrinth seal, having a clearance and passage length, among other things, that govern the amount of dough leaking out.

The radial position in operating mode is selected so that the peripheral surface of the cylinder bars merges into the peripheral surface of the remaining partitioning drum without a rim.

### BRIEF DESCRIPTION OF THE SEVERAL VIEWS OF THE DRAWINGS

Embodiments according to the invention are shown in more detail in the following drawings.

FIG. 1 shows a dough billet kneading machine in a lateral view.

FIG. 2 shows the partitioning drum according to the present invention in a longitudinal sectional view.

FIG. 3 illustrates the partitioning drum according to the invention in a lateral sectional view.

FIG. 4 is a perspective view the partitioning drum of the present invention.

FIG. 5 is a perspective view of the cylinder bar of the present invention.

### DETAILED DESCRIPTION OF THE INVENTION

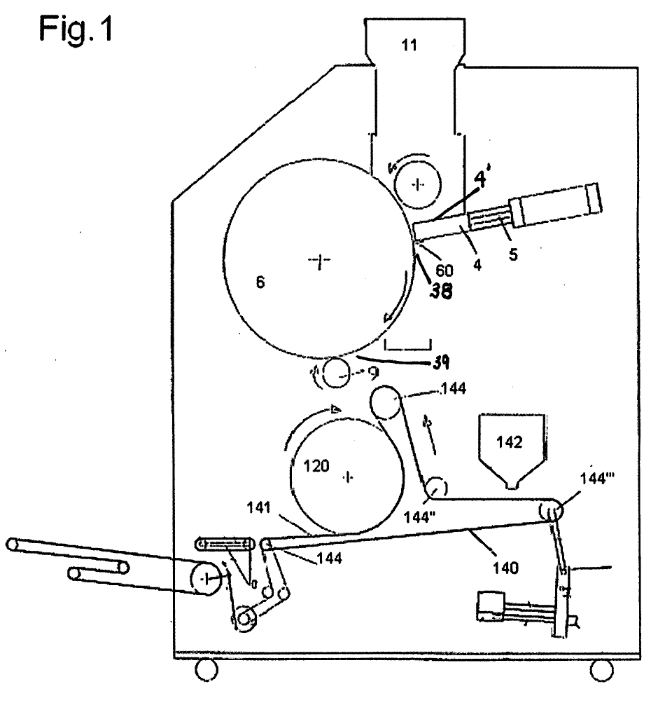

FIG. 1 shows a side view of the portioning unit of the present invention wherein the relevant components, such as a radial pusher 4, a partitioning drum 6, a kneading drum 120, and associated conveyor belts, e.g. a kneading belt 140, and respective guide pulleys of these belts, can be dimensioned perpendicular to the drawing plane of FIG. 1 in any way depending on the capacity requirements of the unit.

In the following, an overall description of the kneading sequence is provided with reference to FIG. 1.

Finished dough is filled into a dough container 11 where it passes through an open upper filler port 4′ of a radial pusher 4.

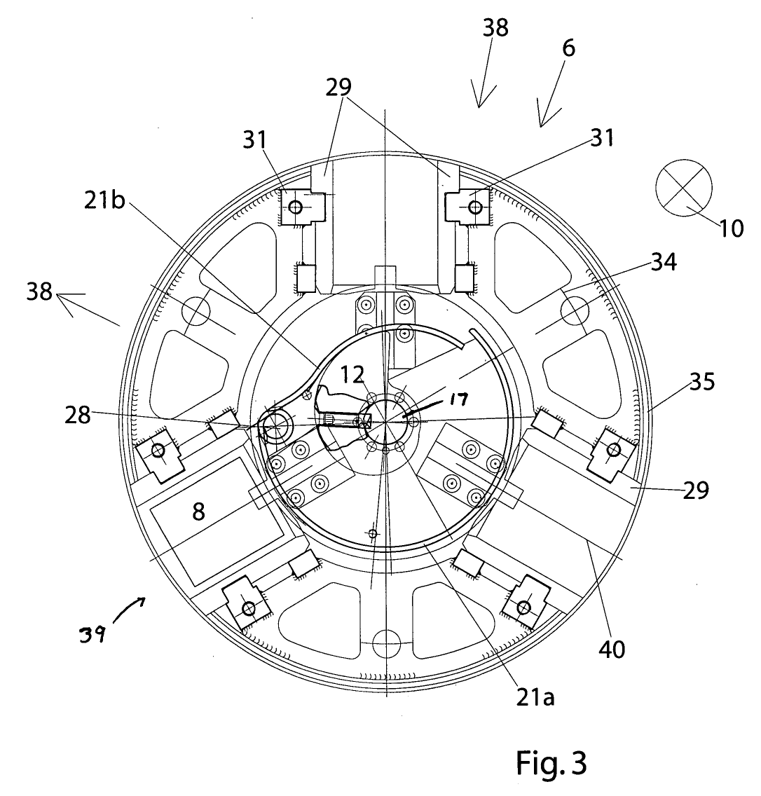

In a partitioning drum 6, on its surface, working orifices are disposed, distributed along different generatrices, as can be seen in FIG. 3. The volume of these orifices is variable through partitioning pistons 8 moving therein.

Partitioning drum 6 rotates permanently, being charged through a pushing motion of radial pusher 4 every time a row of portioning cylinders 7 of partitioning drum 6 is located in front of radial pusher 4, with dough, which radial pusher 4 pushes in front of itself and thereby into the portioning cylinders 7 of partitioning drum 6. For this purpose radial pusher 4 is being actuated by means of a push rod 5.

Since partitioning drum 6 simultaneously continues to rotate, the dough in portioning cylinders 7 is sheared off by a shearing blade 60, which is located on the circumferential surface of partitioning drum 6 tightly abutting to the housing so that in each portioning cylinder 7 of partitioning drum 6 a discrete volume of dough, the so-called dough billet, is located and has a weight that should match a predetermined target value as closely as possible.

Such charging of portioning cylinders 7 of partitioning drum 6 is repeated with each row of portioning cylinders 7 passing in front of radial pusher 4.

Partitioning drum 6 continues in a clockwise rotation so that the dough volume, filled into partitioning drum 6 just above a centerline, leaves dough drum 6 through pushing portioning pistons 8 out, which are located in partitioning drum 6, thereby being engaged by an extraction roller, turning counter-clockwise and thereby being extracted from the working spaces.

Located precisely below this location is a kneading drum 120 which also has indentations in its enveloping surface into which the dough billets drop through appropriately controlling positioning and speed of the kneading drum, which is also rotating continuously.

Kneading drum 120 also continues to rotate clockwise and, promptly after receiving the dough billets, makes contact with an also rotating kneading belt 140, which is being held against the kneading drum in a lower right area through guide pulleys 144 to 144″.

One segment of the kneading belt thereby extends horizontally to the right, at the level of kneading drum 120, through respective transmission by guide pulleys 144″ and 144′″. In this section, the kneading belt passes beneath a flouring station 142, which continually disperses flour onto a top surface of the kneading belt. Due to the kneading belt circulating in counter-clockwise direction, this floured side gets in contact with an outer surface of the kneading drum after passing guide pulleys 144″ and 144.

Guide pulley 144 is located on a lower left side beneath the kneading drum and mounted far enough to the left of kneading drum 120 so that the kneading belt extends to the left roughly horizontally from a lowest point of the kneading drum, forming an approximately horizontal discharge section 141, where the dough billets rest and are removed after exiting the kneading drum.

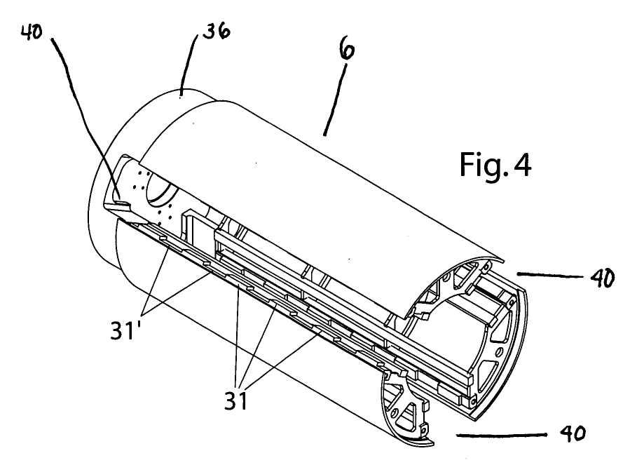

As best illustrated in FIGS. 3 and 4, partitioning drum 6 with its round circumferential surface is fabricated as a welded structure in which panel-shaped, partially perforated rib components 34 are successively arranged in several radial planes through which a centrally aligned opening is disposed. Rib components are connected via the segment-shaped sheets, which are arranged to form shell components 35 over an exterior periphery of all rib segments 34, and welded together thus forming a contiguous peripheral surface over most of the circumference of partitioning drum 6.

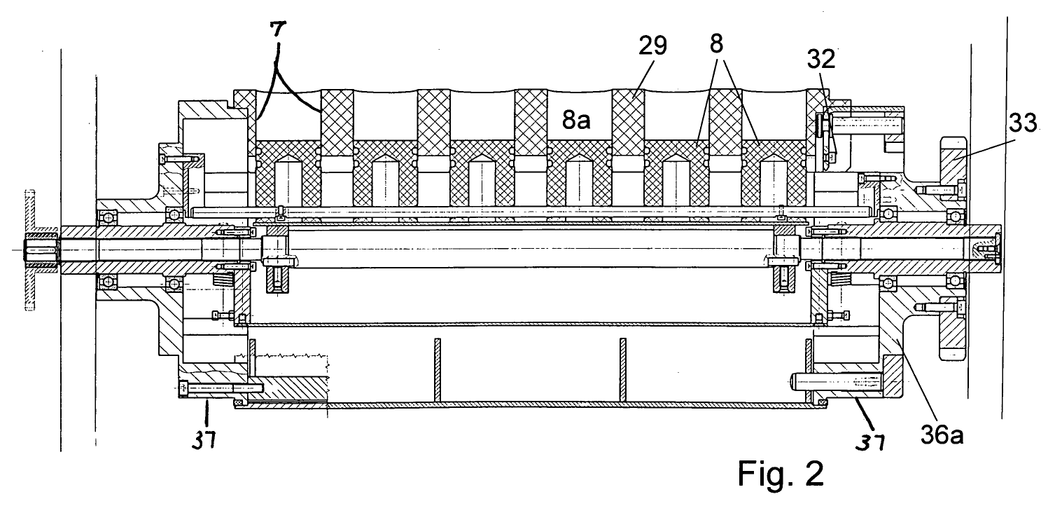

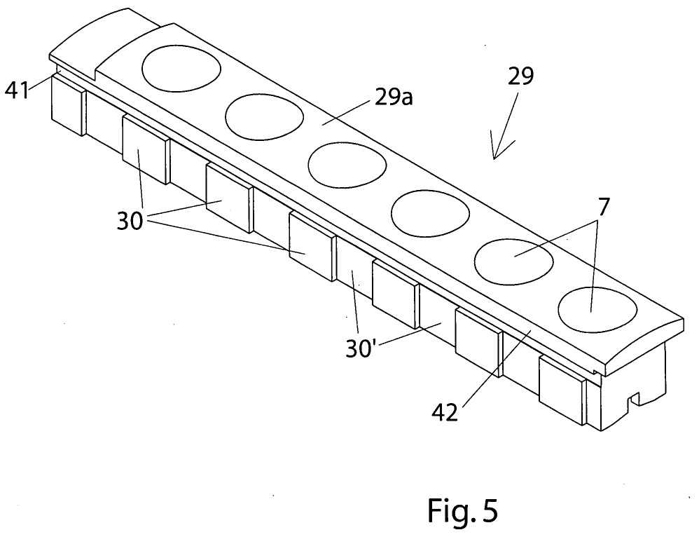

As can be seen in FIGS. 3 and 4, gaps open to the outside are disposed in all rib sections 34 in three locations equally distanced along the circumference, over which the exterior shell elements 35 do not extend. Inserted then into these longitudinally extending grooves or channels 40 are cylinder bars 29, an individual bar shown in FIG. 5 as well as in a longitudinal sectional view in the upper half of FIG. 2. After being locked into a working position, outer circumferential surface 29a of cylinder bars 29 is flush with the outer circumference of shell elements 35, resulting in a closed cylindrical shell surface of partitioning drum 6—except for portioning cylinders 7 disposed in cylinder bars 29.

Portioning cylinders 7 are disposed as radial pass-through openings, radially extending from an exterior surface 29a to an opposing inner surface through cylinder bars 29, and are preferably arranged at regular intervals in axial direction, each having a cylindrical cross section.

As best represented in FIG. 2, portioning pistons 8 are fitted into each portioning cylinder 7 so each can move in a radial manner, each front face being flush with the enveloping surface of partitioning drum 6 in its most forward position, and in each of its most retracted positions defining a portioning volume 8a between each outer front face and the outer circumference of the partitioning drum, which determines the volume of the dough billets produced by the machine.

As best represented by FIG. 5, cylinder bars 29 dispose on their longitudinal outer surfaces at lower levels in longitudinal direction a number of protrusions 30 which are similarly arranged at regular intervals on both longitudinal outer surfaces of cylinder bars 29.

In side flanks of channels 40 of partitioning drum 6 are counter protrusions 31, the axial extension of which is marginally inferior to the length of the distances 30′ between protrusions 30, which in turn have distances 31′ which are marginally larger than axial extension of protrusions 30 on cylinder bars 29.

Furthermore, the length of channels 40 relative to the length of cylinder bars 29 and to the radial position of the counter protrusions 31 in partitioning drum 6 are dimensioned so that it is possible to push cylinder bars 29 from the outside inwards in a radial direction, with their protrusions 30 passing through the counter protrusions 31′ of the partitioning drum towards the inside to the point where protrusions 30 are resting entirely within counter protrusions 31′. Cylinder bar 29 can then be axially displaced by a distance approximately equal to the width of a protrusion 30 which results in its front face striking a stop, mounted preferably in an end cover 36 of partitioning drum 6, where it is held radially in a form locking manner through protrusions 30 and counter protrusions 31, which are in line with each other by now. The longitudinal displacement is being effectuated through a threaded spindle 32 which is supported in one of the end covers 36a in a corresponding inside thread in an axially rotatable manner although coupled to cylinder bar 29 in a longitudinally fixated manner.

The thread is self-locking so that cylinder bar 29 can not shift from this position by itself once it has assumed its working position.

As shown in FIG. 2, the same end cover 36a also supports a drive gear 33 which has a smaller diameter than the exterior diameter of drum 6, so that spindles 32 located with each cylinder bar 29 can be axially threaded out and can thereby be threaded over drive gear 33.

In side flanks of cylinder bars 29, in longitudinal direction and above protrusions 30, extends a continuous groove with its width matching that of the radial extension of counter protrusions 31 for guiding these counter protrusions 31. Above a groove 41 a protrusion 42 extends further outward and sideways than protrusions 30, which serves as a radial stop limiting the insertion of the cylinder bars towards the inside.

In the lower left position of FIG. 2, a portioning piston is shown in a portioning cylinder.

This shows that its radial extension corresponds to that of the portioning pistons, i.e. that of the cylinder bar 29. When portioning piston 8, relative to its extended position as shown in FIG. 2, transitions into its reversed position for receiving dough it then radially protrudes on the inside from cylinder bar 7 and is supported on an outer circumference of guide plate 21, which does not co-rotate with partitioning drum 6 and serves as a control curve.

As best seen in FIG. 3, the guide plate is made from two parts, thus a first fixed guide plate component 21a which extends over approximately two-thirds of the circumference in the interior of the partitioning drum, and a second movable guide plate component 21b which is connected with the first guide plate component 21a at one end through a swivel joint 28.

As shown in FIG. 1, during the partitioning drum's travel between the dough receiving position and the dough expelling position only about 100 to 120 degrees of angle is covered, and exactly this sector is controlled by the movable part of the guide plate, which is pivotable, because the radial pivotal position of this guide plate 21b constitutes the innermost, retracted position of portioning piston 8, thereby controlling the volume of dough billets being produced, which is to be variable and adjustable.

The radial motion curve of portioning piston 8 between a charging position 38 and a discharging position 39, where portioning piston 8 needs to still be or again be in the outermost extended position, is controlled by the curvature of the guide plate 21b, which is per se not modifiable.

Modifiable, however, is the pivotal position of this movable guide plate component 21b, which is supported on its rear surface by one or several longitudinally spaced eccentric cam lobes 12 against which movable guide plate 21b is held by a tension spring not seen.

Eccentric cam lobe or lobes 12, respectively, are rotationally fixed to a camshaft 17 which extends through a central longitudinal passageway through all rib components and, therefore, through the entire partitioning drum 6, as well as through both end covers 36 closing the front faces of partitioning drum 6, protruding outward at least on one side, thereby being accessible and adjustable by rotating it relative to the partitioning drum 6 in order to adjust the portioning volume 8a.

What is claimed is:

1. A portioning unit (1) for doughy substances provided as a component of a dough billet kneading machine, said unit comprising:
at least one radially disposed portioning cylinders (7), which are axially disposed along a generatrix of a powered, rotating partitioning drum (6), are grouped into a cylinder bar (29), and the cylinder bars (29) can be removed from the partitioning drum (6) in radial direction, at least one radially disposed portioning cylinder (7) is located in said rotating partitioning drum so it is open towards the outer surface of the partitioning drum (6), and in which a portioning piston (8) is disposed so it can move in a radial direction.

2. The portioning unit according to claim 1 wherein said cylinder bars (29) are positively locked in said partitioning drum (6) through axial displacement of said cylinder bars (29) which have already been positioned correctly in said radial direction.

3. The portioning unit according to claim 1 wherein axially spaced protrusions (30) are disposed on outer surfaces of said cylinder bars (29), which can be inserted in axial direction under opposing protrusions (31) provided on said partitioning drum (6).

4. The portioning unit according to claim 1 wherein said cylinder bars (29) are made from plastic material and do not contain metallic constituents.

5. The portioning unit according to claim 1 wherein a longitudinal displacement is achieved through the use of a threaded spindle (32) which is bolted to said partitioning drum (6) and remains connected to said cylinder bar (29) throughout operation of said partitioning drum (6).

6. The portioning unit according to claim 5 wherein the required longitudinal displacement is no larger than the diameter of a portioning cylinder (7), and that all components of said partitioning drum (6) protruding into a radial range of said cylinder bars (29) are removed from the position of insertion of said cylinder bar (29) by a distance greater than this displacement.

7. The portioning unit according to claim 1 wherein a stroke of said portioning piston (8) is variable through radial adjustment of a stop curve, serving as rear, inner stop for said partitioning pistons (8) of an entire generatrix in longitudinal direction (10).

8. The portioning unit according to claim 7 wherein said stop curve is a guide plate (21b).

9. The portioning unit according to claim 7 wherein the radial adjustment of said stop curve is effectuated through rotating a cam lobe on a rear side of said stop curve.

10. The portioning unit according to claim 8 wherein said guide plate is pivotable between an outer and an inner pivoting position and is preloaded in the inner pivoting position through a spring.

11. The portioning unit according to claim 7 wherein said guide curve extends over 150° of circumference at most.

12. The portioning unit according to claim 7 wherein the control curve has no steps in axial direction where said cylinder bars can collide during longitudinal displacement.

13. The portioning unit according to claim 1 wherein said partitioning drum (6) is made from radial rib elements (34), wherein a central camshaft (17) with a cam lobe (12) is mounted.

14. The portioning unit according to claim 13 wherein segment-shaped shell elements are placed onto said radial ribs, and said cylinder bars (29) can be inserted in free spaces between the shell segments (35).

15. A partitioning drum for a portioning unit (1) for doughy substances provided as a component of a dough billet kneading machine, said drum comprising:
portioning cylinders (7) which are axially disposed along a generatrix of the partitioning drum (6) are grouped into a cylinder bar (29), and the cylinder bars (29) can be removed from the partitioning drum (6) in radial direction.

16. The partitioning drum according to claim 15 wherein said cylinder bars (29) are positively locked in said partitioning drum (6) through axial displacement of said cylinder bars (29) which have already been positioned correctly in radial direction.

17. The partitioning drum according to claim 15 wherein axially spaced protrusions (30) are disposed on outer surfaces of said cylinder bars (29), which can be inserted in axial direction under opposing protrusions (31) provided on said partitioning drum (6).

18. The partitioning drum according to claim 15 wherein said cylinder bars (29) are made from plastic material and do not contain metallic constituents.

19. The partitioning drum according to claim 15 wherein longitudinal displacement is achieved through use of a threaded spindle (32) which is bolted to said partitioning drum (6) and remains connected to said cylinder bar (29) throughout operation of said partitioning drum (6).

20. The partitioning drum according to claim 19 wherein the required longitudinal displacement is no larger than the diameter of a portioning cylinder (7), and that all components of said partitioning drum (6) protruding into a radial range of said cylinder bars (29) are removed from the position of insertion of said cylinder bar (29) by a distance greater than this displacement.

21. The partitioning drum according to claim 15 wherein a stroke of said portioning piston (8) is variable through radial adjustment of a stop curve, serving as rear, inner stop for said portioning piston (8) of an entire generatrix in a longitudinal direction (10).

22. The partitioning drum according to claim 21 wherein said stop curve is a guide plate (21b).

23. The partitioning drum according to claim 21 wherein the radial adjustment of said stop curve is effectuated through rotating a cam lobe on a rear side of said stop curve.

24. The partitioning drum according to claim 22 wherein said guide plate is pivotable between an outer and an inner pivoting position and is preloaded in the inner pivoting position through a spring.

25. The partitioning drum according to claim 21 wherein said guide curve extends over 150° of circumference at most.

26. The partitioning drum according to claim 21 the control curve has no steps in axial direction, where said cylinder bars can collide during longitudinal displacement.

27. The partitioning drum according to claim 15 wherein said partitioning drum (6) is made from radial rib elements (34), wherein a central camshaft (17) with a cam lobe (12) is mounted.

28. The partitioning drum according to claim 27 wherein segment-shaped shell elements are placed onto said radial ribs, and said cylinder bars (29) can be inserted in free spaces between shell segments (35).

29. The partitioning drum according claim 15 wherein said partitioning drum (6) axially is enclosed through inserted end covers (36) which are provided as turned parts.

30. The partitioning drum according to claim 15 wherein said partitioning drum (6) is provided at its outer axial ends with a circumferential rim (37), into which a dough container (11) engages, guided in an interlocking manner relative to said partitioning drum in axial direction.
